(19) United States
(12) Patent Application Publication
(10) Pub. No.: US 2022/0180179 A1
(43) Pub. Date: Jun. 9, 2022

(54) DETECTING ANOMALIES IN COMPUTER SYSTEMS BASED ON FORECASTED TIMESERIES

(71) Applicant: INTERNATIONAL BUSINESS MACHINES CORPORATION, Armonk, NY (US)

(72) Inventors: Mircea R. Gusat, Langnau am Albis (CH); Athanasios Fitsios, Zurich (CH); Charalampos Pozidis, Thalwil (CH); Konstantinos Kouziou, Patras (GR)

(21) Appl. No.: 17/115,839

(22) Filed: Dec. 9, 2020

(51) Int. Cl. G06N 3/08; G06N 3/04; G06F 16/22

(52) U.S. Cl. CPC G06N 3/08; G06F 16/22; G06N 3/04

(57) ABSTRACT

A computer-implemented method for detecting an anomaly in a computer system. The method comprises accessing a first timeseries of measured values of a quantity related to the operation of the computer system, wherein the first timeseries spans a first time period. Timeseries forecasting is performed to infer a second timeseries of values for the quantity. The second timeseries spans a second time period up to a given time horizon. Aa third timeseries of measured values of the quantity is accessed, wherein the third timeseries spans the second time period up to the time horizon. The second timeseries inferred is subsequently compared with the third timeseries accessed to obtain a comparison outcome. An anomaly score is determined based on the comparison outcome obtained, to potentially detect an anomaly in the computer system. The invention is further directed to an anomaly detection unit and a computer program product.

Aspects of the present invention may have been disclosed by the inventor, or a joint inventor, in the Swiss Federal Institute of Technology Zurich, Master Thesis “Skipper: A Forecasting Model for Non-stationary Multivariate Time-series”, made available to the public on Jun. 8, 2020. These aspects, as they may appear in the claims, may be subject to consideration under 35 U.S.C. § 102(b)(1)(A).

### BACKGROUND

The invention relates in general to a computer-implemented method, a computer system, and a computer program product for detecting an anomaly in a computerized system. In particular, it is directed to a method, a computer system and a computer program product using forecasted timeseries to detect an anomaly.

Computers are used for a wide variety of industrial and consumer applications and are expected to remain fully operational at all times. It is therefore necessary to detect an anomaly (including a malfunction) of a computer system.

Two prevalent approaches in designing anomaly detection systems are known, which are based on signatures or behaviors of data traffic. Signature-based detection relies on the existence of a collection of known events or attack signatures that get updated when a new event or attack is identified. Behavioral detection is useful in defending against novel malicious behaviors, for which no signature is available yet. Behavioral detection typically involves machine learning to create profiles for behaviors of normal network traffic. The profiles are used to detect anomalies, for example novelties or outliers. Such anomalies may include, for example, data traffic having a behavior that significantly diverges from an expected behavior or a normal behavior. A merit of this approach is that it can operate without prior knowledge or traffic assumptions, often being unsupervised in nature.

Machine learning often relies on artificial neural networks which are computational models inspired by biological neural networks in human or animal brains. Such systems have successfully been applied to, for example, speech recognition, text processing and computer vision. There are many types of neural networks, including feedforward neural networks, such as multilayer perceptrons, deep neural networks, and convolutional neural networks, where the latter rely on convolution operations. Additional types of neural networks include recurrent neural networks, wherein connections between the nodes form a directed graph along a temporal sequence, allowing the recurrent neural networks to have a dynamic (temporal) behavior. Neural networks are typically implemented in software. A neural network may be implemented in analog and/or digital hardware, for example, as a resistive processing unit or as an optical neuromorphic system.

Aside from machine learning techniques, various (scalar and vector) forecasting models are known, such as the so-called moving-average, autoregressive, autoregressive moving-average processes, as well as several extensions. Such processes may further include integrated and seasonal autoregressive moving-average processes, such as, for example, the seasonal integrated autoregressive moving-average process, the autoregressive integrated moving-average process, the weakly stationary seasonal autoregressive moving-average process, and the autoregressive fractionally integrated moving-average process, to cite a few. Thanks to such models, timeseries models can be simulated, estimated from data, and used to produce forecasts of future behavior.

### SUMMARY

Embodiments of the present invention disclose a method, a computer system, and a computer program product for detecting an anomaly in a computer system. Embodiments of the present invention include accessing a first timeseries of measured values of a quantity related to operation of the computer system, the first timeseries spanning a first time period; based on the first timeseries accessed, performing timeseries forecasting to infer a second timeseries of values for the quantity, the second timeseries spanning a second time period up to a given time horizon; accessing a third timeseries of measured values of the quantity, the third timeseries spanning the second time period up to the time horizon; comparing the second timeseries inferred with the third timeseries accessed to obtain a comparison outcome; and based on the obtained comparison outcome, determining a first anomaly score to potentially detect an anomaly in the computer system.

Computer methods, systems, and computer program products embodying the present invention will now be described, by way of non-limiting examples, and in reference to the accompanying drawings.

### BRIEF DESCRIPTION OF THE DRAWINGS

The accompanying figures, where like reference numerals refer to identical or functionally similar elements throughout the separate views, and which together with the detailed description below are incorporated in and form part of the present specification, serve to further illustrate various embodiments and to explain various principles and advantages all in accordance with the present disclosure, in which:

FIG. 1 is a flowchart illustrating high-level steps of a method for detecting anomalies in a computer system according to embodiments of the present invention;

FIG. 2 is a block diagram schematically illustrating components of the computer system according to embodiments of the present invention;

FIG. 3 schematically represents an exemplary computing device, suited for implementing method steps according to embodiments of the present invention;

FIG. 4 is a plot representing univariate timeseries of selected key points of interest for the computer system according to embodiments of the present invention;

FIGS. 5A, 5B, 5C and 5D are plots illustrating high-level steps of a method of anomaly detection according to embodiments of the present invention. FIG. 5A depicts a first (univariate) timeseries for a given key point of interest of a computer system. FIG. 5B depicts the corresponding autocorrelation function, as used in embodiments to detect a temporal pattern for the timeseries and whether such a timeseries is predictable. FIGS. 5C and 5D each depict how a second timeseries inferred from the first timeseries using a forecasting method is compared to actual data observed, to detect a potential anomaly as shown in FIG. 5D, or to not detect a potential anomaly as shown in FIG. 5C;

FIG. 6 is a cloud computing environment according to embodiments of the present invention; and

FIG. 7 shows abstraction model layers according to embodiments of the present invention.

### DETAILED DESCRIPTION

The following description is structured as follows. General embodiments and high-level variants are described in Section 1. Section 2 describes more specific embodiments and technical implementation details.

### 1. General Embodiments and High-Level Variants

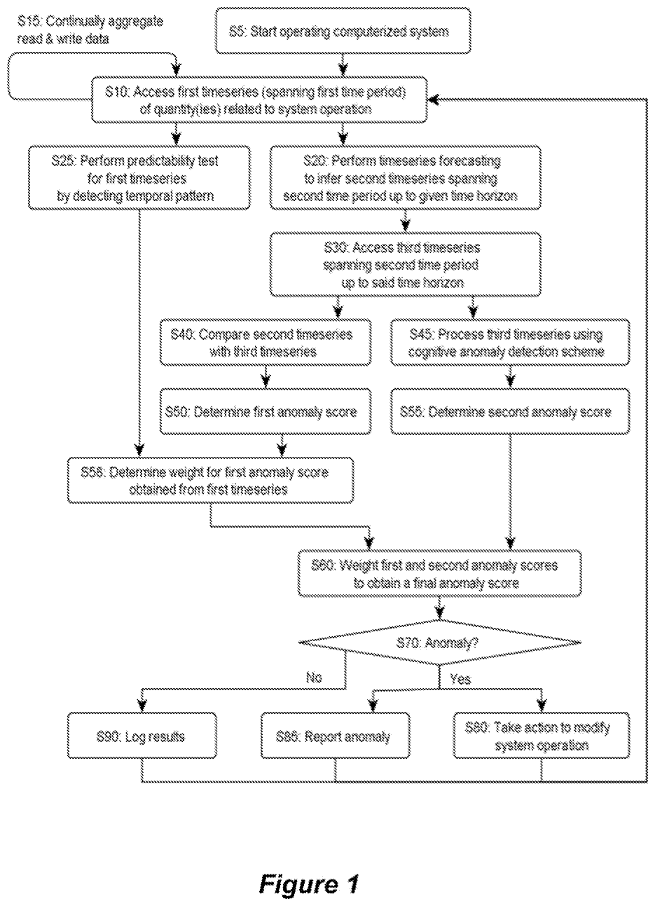

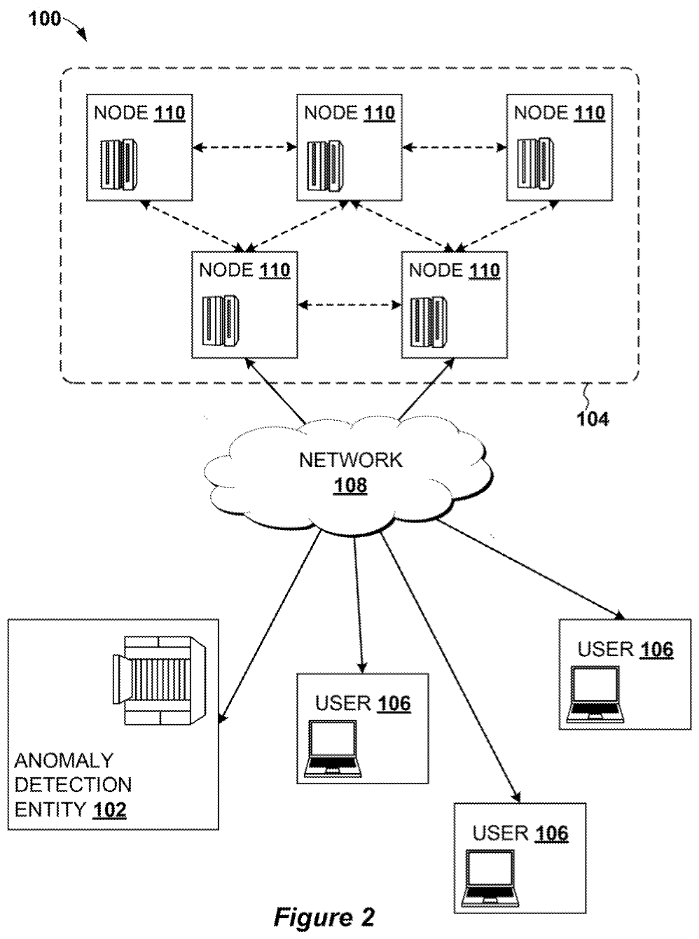

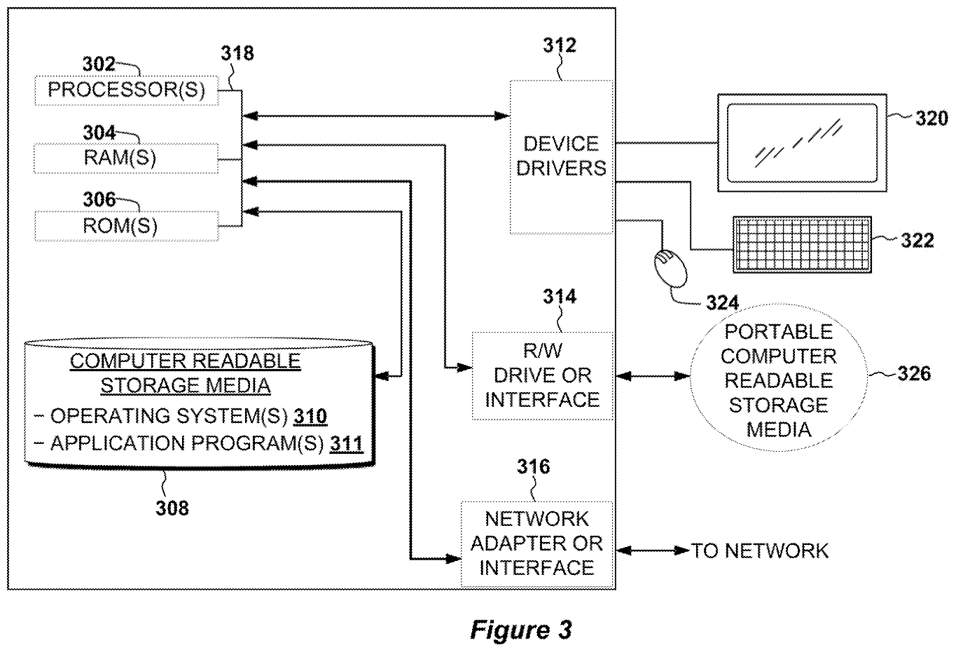

In reference to FIGS. 1-5, aspects of the invention are first described, which concern a computer-implemented method for detecting anomalies in a computer system 100. Note, this method and its variants are collectively referred to as the “present methods” in this document. All references Sn refer to methods steps of the flowchart of FIG. 1, while numeral references pertain to physical parts or components of the computer system 100 shown in FIG. 2 and the computing device shown in FIG. 3.

The present methods consume and produce timeseries which include a series of data ordered by the time the data are collected or produced, usually spaced at equal intervals. Timeseries are commonly specified by time-value pairs, for example, of the form {tᵢ, vᵢ}, where the values vi can be scalars or arrays of any dimension, typically all of equal dimensionality. The time values may possibly be omitted, especially where they are spaced at equal intervals. Such timeseries can be univariate (involving one parameter, computed value, or measured quantity) or multivariate (involving several parameters, computed values, or measured quantities) for each time step tᵢ.

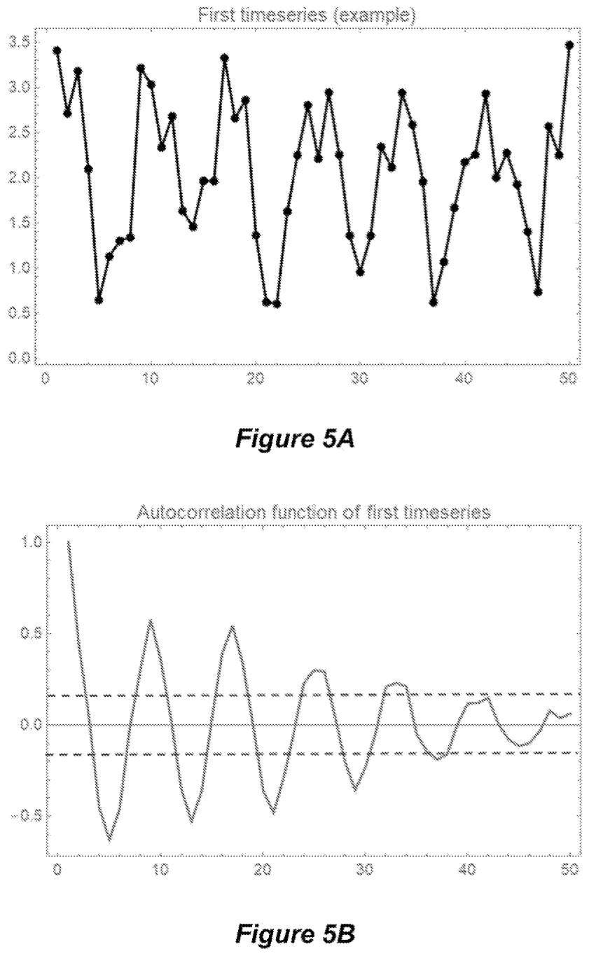

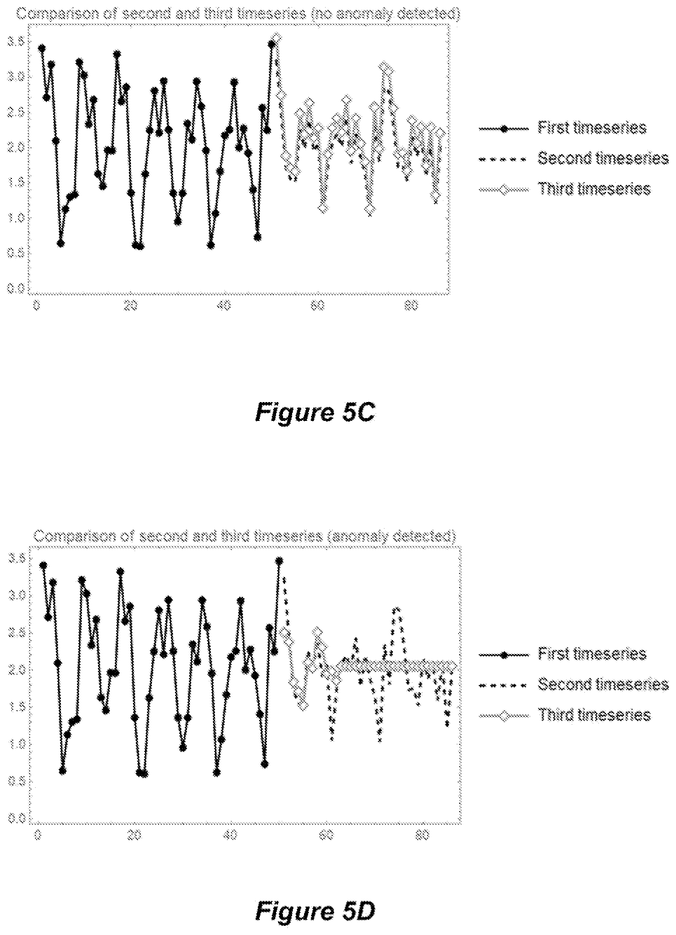

The present method begins at step S5, start operating the computer system 100. The present method accesses a reference timeseries at step S10 (FIG. 1), hereinafter referred to as “the first timeseries”. The first timeseries spans a first time period. For example, the timeseries shown in FIG. 5A ranges from t₁=1 to t₅₀=50, where the unit of time is unimportant. The first timeseries aggregates measured values of a quantity (or several quantities) related to the operation of the computer system 100.

Next, timeseries forecasting is performed at step S20, based on the first timeseries accessed at step S10, in order to infer a “second timeseries” of values for the same quantity. The second timeseries spans a second time period, which normally starts where the first period ends, up to a given time horizon. That is, the second time period typically spans a portion of the “future” of the first time period. Note, the second time period may differ from the first time period. The forecasting model used is preferably an integrated and seasonal autoregressive moving-average process. This is exemplified in FIG. 5C, which shows an example of a second timeseries (dotted curve), as inferred from a first timeseries (solid black line), here using a seasonal integrated autoregressive moving-average process.

A third timeseries is then accessed at step S30, which concerns measured values of the same quantity (or the same quantities) as used to obtain the first timeseries. Importantly, the third timeseries spans the second time period, i.e., the same period as spanned by the second time series, up to the same time horizon. The first and third timeseries correspond to actual signals as measured for the computer system 100, where the second timeseries represents inferred values, i.e., values predicted according to the forecasting step S20.

The second timeseries (as inferred at step S20) is subsequently compared with the third timeseries (as accessed at step S30) at step S40, which results in a given comparison outcome. The latter may for example be a measure of a correlation or a distance. More specifically, comparing the second timeseries with the third timeseries may involve measuring a correlation between the two timeseries or, determining a distance (for example, cosine, angular, or Euclidian distance) obtained via any suitable metric. Finally, based on the comparison outcome obtained, an anomaly score is determined at step S50, to potentially detect an anomaly at S70, and report an anomaly at S85, in the computer system 100. The anomaly score is typically obtained based on a heuristic.

FIG. 5C shows an example of a third timeseries (gray line), which, in this ideal example, closely matches the forecast (dotted line). In that case, no anomaly detection will be detected. On the contrary, where the third timeseries happens to substantially deviate from the predicted timeseries, as illustrated in FIG. 5D, an anomaly is detected. FIGS. 5A-5D have an illustrative purpose and were obtained using synthetic data.

The present approach exploits properties of statistical predictions to characterize potential anomalies in the computer system 100. This is achieved by comparing timeseries predictions (which assume statistically “normal”, temporal evolutions of data) to actual timeseries observed. Now, the actual data obtained may potentially show substantial deviations to the predictions, and such deviations may precisely indicate the occurrence of anomalies in the computer system 100.

Anomalies may arise, for example, due to malicious actions, frauds, or system failures. Anomalies may generally relate to data traffic anomaly, such as network attacks (for example, on the business environment), unauthorized accesses, network intrusions, improper data disclosures or data leakages, system malfunctions, or data and/or resources deletion, etc. Anomaly detection is important in various domains, such as cybersecurity, fraud detection, and healthcare.

The anomaly score (i.e., a number or a set of numbers) may for example be assessed to detect whether an anomaly occurs (or occurred) in the computer system 100. For example, the methods disclosed herein are preferably performed in real-time to potentially detect a current anomaly. However, such methods may also be performed using past timeseries, to detect past anomalies of the computer system 100, for example, for forensic purposes.

Whenever an anomaly is detected (based on the obtained anomaly score), then it may be instructed at step S80 to take action in respect of the computer system 100, to modify a functioning thereof. That is, appropriate decisions may be made, for example, in the interest of preserving the computer system 100 and/or its environment. Both the type of action taken and its intensity may depend on the anomaly score obtained and the anomaly detected. In some cases, a preemptive action may be taken, to preempt adverse phenomena. For example, actions taken (at step S80) to address anomalies, either detected or anticipated, may include interrupting data traffic, re-routing data traffic, deleting data, or shutting down select parts of the computer system 100 as necessary. More generally, actions taken at step S80 modify the way the computer system 100 normally functions in response to detected or anticipated anomalies.

Note, the above explanations mostly refer to a single, first timeseries (and then correspondingly to a single second timeseries, etc.), for simplicity. However, several univariate timeseries, or a single multivariate timeseries, or even several multivariate timeseries may similarly be assessed for several system-related quantities, to perform predictions and then determine potential anomalies. Plus, the present method steps are typically performed in a continual (i.e., cyclic) manner, whereby multiple timeseries are accessed in inferred, which may possibly partly overlap (time-wise), to be able to continually monitor the computer system 100.

The following explains how suitable data can be collected to form timeseries as used in the methods described herein. This first requires explaining how the computer system 100 works. The computer system 100, as depicted in FIG. 2, includes various components, such as, for example, an anomaly detection entity 102, a network of cloud resources 104 (hereinafter “cloud network”), and multiple users 106, all of which are connected via a communications network 108 (hereinafter “network”). The cloud network 104 further includes computerized nodes 110 (hereinafter “nodes 110”). As described below with reference to FIG. 3, the anomaly detection entity 102 and the nodes 110 may each include internal and external hardware components. In all cases, the operation of the computer system 100 results in data being written to or read from the various hardware components of each of the nodes 110, via write channels and read channels, respectively.

The computer system 100 typically has a von Neumann architecture, whereby the nodes 110 of the cloud network 104 are interconnected via signal lines, and the various hardware components within each of the nodes 110 are interconnected via signal lines. The signal lines connecting the various hardware components within each node 110 correspond to buses, for example the communication fabric 318 in FIG. 3. Main buses include a control bus, a data bus, and an address bus, each allowing for parallel data transmission between the various hardware components. Thus, each hardware component may exchange data with other components via a pair of channels. Such channels refer to logical channels and may not necessarily require independent physical channels

Similarly, data is exchanged between nodes 110 via pairs of channels, depicted as dashed arrows in FIG. 2. In both cases, each pair of channels include a read channel and a write channel. Note, read and write channels should be understood in a broad sense. For example, write channels may notably include store and transmit channels, while read channels may include load and receive channels. Several write channels and several read channels are likely involved in operation of the computer system 100. Such channels normally refer to logical channels and may not necessarily require independent physical channels. It should be noted that data exchanged on a physical channel are often time-multiplexed.

Data consumed and produced by the nodes 110, the various hardware components of each node 110, or both is referred to as read data and write data. Alternatively, such data may also be referred to as “direct data”, as opposed to “indirect data”. Direct data are data transmitted along the read and write channels. For example, direct data can include read data, for example, data produced by the nodes 110, the various hardware components of each node 110, or both. Direct data can also include write data, for example, data being consumed by the nodes 110, the various hardware components of each node 110, or both.

Direct data can be obtained by sampling data transmitted along data paths to or from the nodes 110, the various hardware components of each node 110, or both, through the read channels and the write channels. Known data sampling mechanisms or techniques may be used. Direct data may notably be obtained via control paths of the computer system 100. Direct data collected by sampling the read channels and the write channels includes moving data, for example data sent between the nodes 110, the various hardware components of each node 110, or both. Direct data does not include static data, for example data that is statically stored on resources of the computer system 100 or the cloud network 104. In particular, for example, direct data may include read/write data from/to a same CPU, a same storage element, or a same memory system.

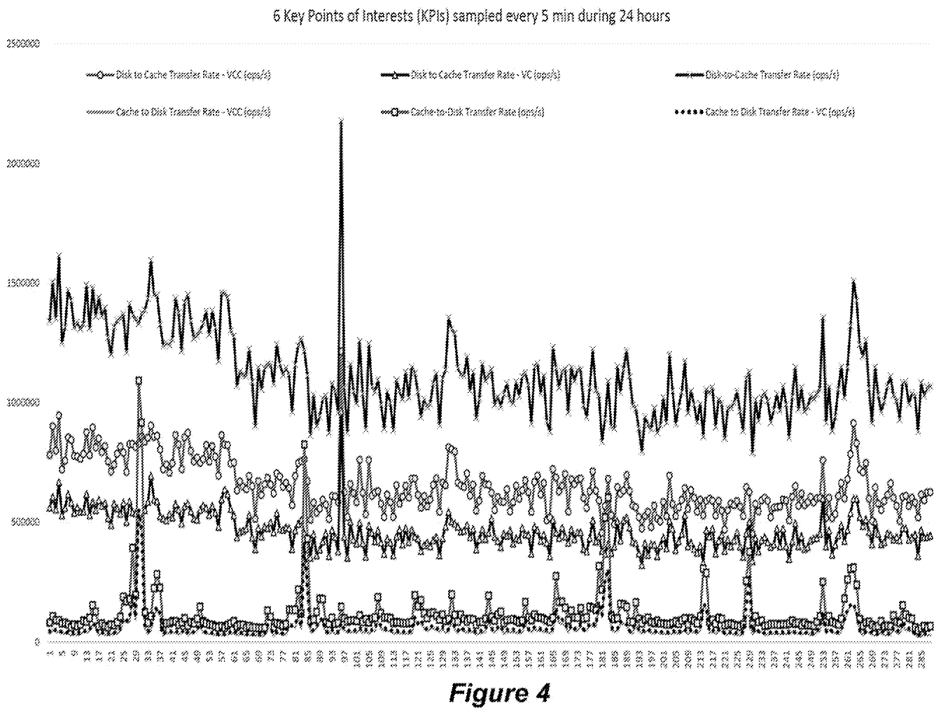

In addition to direct data, the computer system 100 may also use and/or produce indirect data. Indirect data may notably include data used by the computer system 100 to ensure execution of the normal processes, such as control data, for example, indicative of traffic state, congestion, etc. Such indirect data may further include key performance indicators (KPIs), which may for instance pertain to one or each of the read channels and the write channels. Between 2 and 800 KPIs are preferably used for the present purposes. KPIs can be computed based on data collected from the computer system 100, based on any suitable metric. For example, streaming KPIs may advantageously be used. Similar to direct data and other kinds of indirect data, KPIs may be formed as timeseries, for example, as multiple timeseries for multiple KPIs, respectively, where each timeseries corresponds to a given KPI. The timeseries are aggregated at step S15 based on data collected at regular time intervals, from the computer system 100, as illustrated in FIG. 4. In this example, six KPIs are depicted, which are sampled over a period of 24 hours. Such KPIs relate to disk-to-cache transfer rates or, conversely, cache-to-disk transfer rates, possibly using volume cache or volume copy cache metrics for volumes. Univariate series are assumed in this example. Such KPIs are sampled at a frequency of 288 times per day, that is every 300 seconds or every 5 minutes. Such a frequency happens to be a practical upper bound of common long short-term memory, gated recurrent units, and recurrent neural network memories. A longer period would require a special mechanism, such as the so-called skip, attention, or temporal convolutional network/dilated convolutional neural network mechanisms. This approach may notably be used for monitoring general computers, as well as memory and storage hardware, and load/store engines, for example. In other approaches, collected data may need be up/sub-sampled, in order to form the required timeseries. More generally, several univariate and/or multivariate timeseries may be collected and aggregated for several KPI metrics.

Any or each of direct and indirect data may be used to define quantities of interest, as necessary for each type of channel (i.e., read and write channels), and serve as measurands of states of the system. Such data are used to form timeseries, based on which anomalies may potentially be detected, as explained above.

Data collected may be aggregated and directly processed. In variants, the collected data may possibly be subject to feature extraction in the compressed latent space, to go from a large number, for example 1000 or more KPIs, to a compressed representation including most important features.

The methods disclosed herein preferably involve distinct anomaly detection schemes. For example, two detection schemes may be concurrently involved to detect respective anomaly scores, as is discussed in greater detail below with reference to FIG. 1. That is, the above anomaly score may be a first anomaly score and the present methods may concurrently seek to determine a second anomaly score.

The second anomaly score may for instance be obtained at step S55 by processing the third timeseries using a cognitive anomaly detection scheme (i.e., a machine learning model, e.g., based on artificial neural networks), at step S45. The cognitive anomaly detection scheme conceptually differs from the timeseries forecasting used at step S20. Unlike the timeseries forecasting used at step S20s, the cognitive anomaly detection scheme is not based on timeseries forecasting. Examples of suitable cognitive models are discussed below. Next, each of the first anomaly score and the second anomaly score can be weighted, step S60. This makes it possible to obtain a third anomaly score, based on weighted contributions of the first anomaly score and the second anomaly score. Depending on the weights obtained, the third score may possibly be equal to the first score (if the second weight is zero) or the second score (if the first weight is zero). That is, in extreme cases, only the cognitive score or only the forecasting score may eventually be taken into account to detect a potential anomaly. However, in practice, anomalies will typically be detected based on non-zero contributions from each score. Beyond mere weighting schemes, the third score may more generally be obtained via a function taking the first and second scores as arguments.

The cognitive anomaly detection scheme may notably involve an autoencoder, e.g., a variational autoencoder, or a convolutional neural network. In an embodiment, read and write data are separately processed, in which case a multiple-channel neural network, such as a convolutional neural network (CNN) or a recurrent neural network, may be employed as a filter, to exploit adjacency of strongly cross-correlated KPIs. As the computer system 100 is being operated, two types of data may be accessed, including first data pertaining to write channels and second data pertaining to read channels of the system. Then, the first data and the second data accessed may be separately fed into the multiple-channel neural network. This network includes two input channels defining independent subsets of one or more neuron layers and an output neuron layer, the latter connected by each of the independent subsets of layers. This way, the neural network may separately process the first data and the second data in the independent subsets of layers and produce one or more values in output of the output layer, based on which the second anomaly score is obtained.

Timeseries forecasting is one type of cognitive algorithm, while an anomaly detection scheme uses other types of cognitive approaches, as described below.

The present methods preferably perform, at step S25, a predictability test in respect of the first timeseries accessed at step S10, in order to determine the relative weight to be assigned to the first anomaly score. The predictability test aims at detecting a temporal pattern for the first timeseries at step S25. Assessing the temporal pattern obtained at step S25 gives rise to an assessment result, which is used to determine at step S58 the extent to which the first anomaly score is taken into account in determining the third anomaly score. The first anomaly score and the second anomaly score are accordingly weighted at step S60. Note, contrary to the flow illustrated in FIG. 1, this predictability test may possibly be performed at step S25 prior to performing at step S20 the timeseries forecasting. This allows to skip steps S20, S30, S40, and S50 if it appears that the timeseries as accessed at step S20 is unpredictable. In that case, the third anomaly score is simply taken as the second anomaly score (the first anomaly score does not even need to be determined). However, as stated, anomalies will typically be detected based on contributions from each of the first and second anomaly scores in practice.

The above temporal pattern may be detected by computing an output of a function taking the first timeseries (or elements thereof) as argument. This function may for instance be an autocorrelation function (as assumed in FIG. 5B), a Fourier transform, or a wavelet transform. Several functions may possibly be used, including two or more of the above functions. A wavelet transform often leads to more accurate results, also being more informative about events that occurred. Relying on the autocorrelation function is simpler in practice and therefore preferably used, as described in detail below.

For example, the predictability test may be performed by selecting top-k peaks of the output of the autocorrelation function, based on their intensities. The temporal pattern is then assessed based on attributes of the selected peaks (e.g., their positions). The autocorrelation function peaks are preferably selected by thresholding peaks of the output of the autocorrelation function. For instance, FIG. 5B depicts the autocorrelation function obtained for the timeseries shown in FIG. 5A, as well as dashed lines indicating thresholds, based on which peaks are selected. In turn, analyzing the position of the peaks allows to conclude as to whether a sufficient temporal pattern exists, based on which it is possible to conclude as to the extent to which the first timeseries (FIG. 5A) is predictable. This, in turn, impacts the weighting scheme, i.e., the weight assigned to the first anomaly score. When the first timeseries appears to be sufficiently predictable, then a forecasting method may advantageously be implemented to eventually conclude as to a possible anomaly.

In an embodiment, beyond predictability purposes, thresholding techniques may also be used to detect anomalies. I.e., only those anomaly scores exceeding a given, pre-determined threshold may lead to an actual anomaly detection. In variants, a cognitive model may be trained to classify the individually obtained at steps S50, S55 anomaly scores as anomalies (or not), for example.

As noted earlier, the present methods are typically performed for multiple timeseries, in a concurrent and/or continual manner. For example, a timeseries pertaining to a given, respective quantity may be continually collected as a sliding temporal window. Still, multiple timeseries may be concurrently collected (for respective quantities), yet in a repeated manner, i.e., as a continual process. Thus, multiple “first” timeseries may concurrently and/or continually be accessed, at step S10. The subsequent steps (in particular steps S20, S30, S40, and S60) may thus be performed in a concurrent (i.e., parallel) manner and/or repeatedly performed. Specifically, when multiple first series are accessed concurrently, all the subsequent processing steps can be performed in a concurrent manner for each of the first series obtained.

A continual process is notably useful to monitor the computer system 100 in real time. In that case, the first timeseries accessed at step S10 span respective time periods, which, however, partly overlap, temporally speaking. Forecasts, step S20, are repeatedly performed, to repeatedly infer second timeseries that span time periods up to respective time horizons. Each “third” timeseries accessed at step S30 (i.e., when reaching the corresponding time horizon) is subsequently compared to a corresponding second timeseries as inferred at step S20, to conclude (step S70 anomaly detected answer: Yes) as to a potential anomaly. Outcomes of step S70 may possibly give rise to logs (step S70 anomaly detected answer: No anomaly is detected) to step S90, or reports (if an anomaly is detected, continuing to step S85).

Timeseries that are concurrently accessed typically correspond to respective quantities, e.g., KPIs, of the computer system 100 (they are univariate timeseries). At each time instant (e.g., every 5 minutes), multiple first timeseries are accessed at step S10, each spanning a same first time period. Then, multiple timeseries forecasts are performed at step S20 based on the multiple first timeseries accessed, to infer multiple second timeseries of values for the quantities, the multiple second timeseries spanning a same second time period up to a same time horizon. Multiple third timeseries are subsequently accessed S30 (e.g., upon reaching that time horizon), where each of the multiple third timeseries spans the second time period up to the time horizon. This, in turn, allows each of the multiple second timeseries inferred at step S20 to be compared at step S40 with a respective one of the multiple third timeseries accessed at step S30 to obtain multiple comparison outcomes. Next, multiple anomaly scores may possibly be obtained, based on which a final anomaly score is computed, using any suitable heuristic. In variants, the final anomaly score may be directly determined based on the multiple comparison outcomes, again using an appropriate heuristic. In other variants evoked earlier, the timeseries are compressed, such that less data need be processed.

Note, a predictability test may possibly be performed at step S25 in respect of the multiple first timeseries accessed, as explained earlier. This, in turn, may be used to determine at step S58 the extent to which the multiple comparisons performed are taken into account in determining the final anomaly score. For example, one may attempt to detect, at step S25, a temporal pattern by computing autocorrelation functions of each of the multiple first timeseries, and then summing the resulting autocorrelation functions, prior to selecting top-k peaks of the summed functions, based on their intensities. In that case, only a single temporal pattern has to be assessed, for example, based on attributes of the selected peaks of the superimposed autocorrelation function.

The steps of the present methods may for instance be performed at a single computer, for example the anomaly detection entity 102, or at several computers, which is (or are) in data communication with the computer system 100. In some embodiments, the anomaly detection unit 10 may be performed on a single node, or several nodes, for example nodes 110 of the cloud network 104.

### 2. Specific Embodiments—Technical Implementation Details

Referring now to FIG. 1, the method starts operating the computer system 100 at step S5, FIG. 1. A first timeseries is accessed at step S10. The first time series spans a first time period. The first time series relates to measured values of one or more quantities, which themselves relate to the operation of the computer system 100. Read and write data are continually aggregated at step S15. Specifically, the first timeseries is formed based on read and write data which is aggregated at step S15 over the first time period. Once all required data have been aggregated, such data are assembled to form the first timeseries.

Timeseries forecasting is performed at step S20, to infer (i.e., predict) a second timeseries. The second timeseries spans a second time period extending up to given time horizon, as per the forecasting performed. Next, a third timeseries is accessed at step S30. The third timeseries relates to measured values of the same quantities but spans the same second time period (i.e., up to the time horizon mentioned above) that corresponds to the inferred timeseries. The second timeseries is compared with the third timeseries at step S40. Based on this comparison, a first anomaly score is determined at step S50, consistently with essential aspects of the method described in section 1.

In parallel to steps S40 and S50, the third timeseries may be processed using a cognitive anomaly detection scheme, at step S45. This allows a second anomaly score to be determined at step S55. As stated earlier, the cognitive anomaly detection scheme differs from the timeseries forecasting method used.

In parallel to the flow S20-S30-S40-S55, a predictability test is performed for the first timeseries at step S25, by detecting a temporal pattern. The aim is to detect the extent to which the first timeseries is predictable according to the forecasting method, in order to subsequently determine (step S58) a relative weight for first anomaly score obtained from the first timeseries. Weights can accordingly be assigned to each of the first anomaly score and the second anomaly score at step S60. A final anomaly score can then be obtained, based on the weighted anomaly scores.

At step S70, the method assesses the final anomaly score to identify a potential anomaly in the computer system 100. If no anomaly is finally detected at step S70 (step S70: No), the method may simply log the results at step S90. If, however, an anomaly is detected (step S70: Yes), then the method may report this (step S85) where necessary and take steps (S80) to modify the operation of the computer system 100, in view of remedying the anomaly (e.g., by modifying the operation of the computer system 100 or shutting it down).

Next, another cycle can be started; a new timeseries may be accessed at step S10, to potentially detect another anomaly, and so on.

Several “first” anomalies may continually be accessed, which may be processed concomitantly in view of performing several assessments S10-S70, in parallel or in a time-overlapping manner, as discussed in section 1.

Computer systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly-interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

Referring to FIG. 2, the computer system 100 is shown according to aspects of the present invention. Specifically, FIG. 2 schematically represents the computer system 100, which includes the anomaly detection entity 102 in data communication with the nodes 110 of the cloud network 104. The anomaly detection entity 102, the cloud network 104, and the users 106 are all connected via the network 108. The cloud network further includes multiple nodes 110.

According to aspects of the invention, the computer system 100 may include any number of components, for example, the anomaly detection entity 102, the cloud network 104, and the users 106; however, only a discrete number of each is shown for illustrative purposes only. It may be appreciated that FIG. 1 provides only an illustration of one implementation and does not imply any limitations with regard to the environments in which different embodiments may be implemented. Many modifications to the depicted environments may be made based on design and implementation requirements.

The anomaly detection entity 102 is enabled to run an anomaly detection program corresponding to the methods described herein. In an embodiment, the anomaly detection program may run primarily on the anomaly detection entity 102. In an alternative embodiment, the anomaly detection program may run on multiple anomaly detection entities 102. In yet another embodiment, the anomaly detection program may run on the nodes 110 of the cloud network 104. It should be noted, however, that processing for the anomaly detection program may, in some instances be shared amongst one or more anomaly detection entities 102 and one or more nodes 110 in any ratio. Further, in another embodiment, the anomaly detection program may operate on more than one anomaly detection entity 102, node 110, or some combination of anomaly detection entities 102 and nodes 110, for example, a plurality of anomaly detection entities 102 communicating across the network 108 with a single node 110.

In other embodiments, the computer system 100 consists of a single machine and the anomaly detection entity 102 is an element or component of the single machine. Thus, various architectures can be contemplated, in which the anomaly detection entity 102 is used to detect anomalies in a computer system.

The anomaly detection entity 102 is designed for detecting anomalies in the computer system 100, or in at least one example, across the various nodes 110 of the cloud network 104. As previously described above, the anomaly detection entity 102 includes internal and external hardware components, as described below with reference to FIG. 3.

According to an embodiment, the methods described herein are stored as an anomaly detection program on the computer readable storage media (308) of the anomaly detection entity 102. The anomaly detection program can be loaded in the memory (304,306) of the anomaly detection entity 102 and configured to perform steps of the methods disclosed herein. For example, as described above, the anomaly detection entity 102 may access a first timeseries and, based on the first timeseries accessed, perform timeseries forecasting to infer a second timeseries. The anomaly detection entity 102 may further access a third timeseries and then compare the second timeseries inferred with the third timeseries to determine an anomaly score and potentially detect an anomaly in the computer system 100, also as described above.

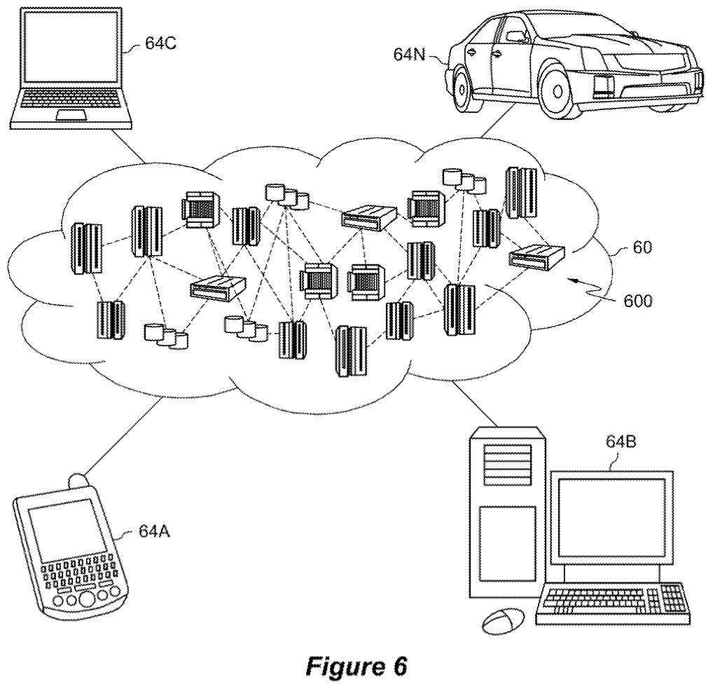

The cloud network 104 may resemble a cloud network similar to the cloud computing environment 60 described below with reference to FIG. 6. In some cases, for example, the nodes 110 store and deploy resources, to provide cloud services to the users 106, which may include companies or other large infrastructures.

The cloud network 104 facilitate the sending and receiving of data between the nodes 110. The cloud network 104 may include wired connections, wireless connections, fiber optic connections, or some combination thereof. In general, the cloud network 104 can be any combination of connections and protocols that will support communications between the nodes 110. The cloud network 104 may include various types of networks, such as, for example, a local area network (LAN), a wide area network (WAN) such as the Internet, a telecommunication network, a wireless network, a public switched network and/or a satellite network.

Similar to the cloud network 104, the network 108 may also include wired connections, wireless connections, fiber optic connections, or some combination thereof. In general, the network 108 can be any combination of connections and protocols that will support communications between the anomaly detection entity 102 and the cloud network 104. The network 108 may include various types of networks, such as, for example, a local area network (LAN), a wide area network (WAN) such as the Internet, a telecommunication network, a wireless network, a public switched network and/or a satellite network.

In various embodiments, the anomaly detection entity 102 and/or the nodes 110 may be, for example, a laptop computer, tablet computer, netbook computer, personal computer (PC), a desktop computer, a personal digital assistant (PDA), a smart phone, a mobile device, or any programmable electronic device capable of communicating with each other via the network 108. As described with reference to FIG. 3, the anomaly detection entity 102 and the nodes 110 may each include internal and external components.

Referring now to FIG. 3, a block diagram of internal and external hardware components of a computing device, such as, for example, the anomaly detection entity 102 or the nodes 110 of the computer system 100 of FIG. 2, is shown in accordance with embodiments of the present invention. It should be appreciated that FIG. 3 provides only an illustration of one implementation and does not imply any limitations with regard to the block diagram in which different embodiments may be implemented. Many modifications to the depicted diagram may be realized.

The computing device of FIG. 3 may include one or more processor 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The read/write drive or interface 314 is used to read from and write to one or more portable computer readable storage media 326. Application programs 311 on the computing device may be stored on one or more of the portable computer readable storage media 326, read via the respective read/write drive or interface 314 and loaded into the respective computer readable storage media 308. Furthermore, the application programs 311 may include one or more separate programs, each of which includes executable instructions for implementing logical functions. For example, the application program 311 may include instructions for or arising from the execution of the computerized methods described herein in accordance with exemplary embodiments. The one or more operating systems 310 essentially control the execution of other computer programs or instructions, and provide scheduling, input-output control, file and data management, memory management, and communication control and related services.

The computing device may also include a network adapter or interface 316, such as a TCP/IP adapter card or wireless communication adapter (such as a 4G wireless communication adapter using OFDMA technology). Application programs 311 on the computing device may be downloaded to the computing device from an external computer or external storage device via a network (for example, the Internet, a local area network or other wide area network or wireless network) and network adapter or interface 316. From the network adapter or interface 316, the application programs 311 may be loaded onto the computer readable storage media 308. The network adapter or interface 316 further enables data communication between different computing devices, for example, between the anomaly detection entity 102 and the nodes 110, or between different nodes 110.

The computing device may also include a display screen 320, a keyboard or keypad 322, and a computer mouse or touchpad 324. The device drivers 312 interface to the display screen 320 for imaging, to the keyboard or keypad 322, to the computer mouse or touchpad 324, and/or to the display screen 320 for pressure sensing of alphanumeric character entry and user selections. The device drivers 312, the read/write drive or interface 314 and the network adapter or interface 316 may comprise hardware and software stored on the computer readable storage media 308 and/or the ROM 306).

The programs and methods described herein are identified based upon the application for which they are implemented in specific embodiments of the invention. However, it should be appreciated that any particular nomenclature herein is used merely for convenience, and thus the invention should not be limited to use solely in any specific application identified and/or implied by such nomenclature.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access a normalized search engine or related data available in the cloud. For example, the normalized search engine could execute on a computing system in the cloud and execute normalized searches. In such a case, the normalized search engine could normalize a corpus of information and store an index of the normalizations at a storage location in the cloud. Doing so allows a user to access this information from any computing system attached to a network connected to the cloud (e.g., the Internet).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, illustrative cloud computing environment 60 is depicted. As shown, cloud computing environment 60 includes one or more cloud computing nodes 600 with which local computing devices used by cloud consumers, such as, for example, personal digital assistant (PDA) or cellular telephone 64A, desktop computer 64B, laptop computer 64C, and/or automobile computer system 64N may communicate. Cloud computing nodes 600 may communicate with one another. They may be grouped (not shown) physically or virtually, in one or more networks, such as Private, Community, Public, or Hybrid clouds as described hereinabove, or a combination thereof. This allows cloud computing environment 60 to offer infrastructure, platforms and/or software as services for which a cloud consumer does not need to maintain resources on a local computing device. It is understood that the types of computing devices 64A-N shown in FIG. 6 are intended to be illustrative only and that cloud computing nodes 600 and cloud computing environment 60 can communicate with any type of computerized device over any type of network and/or network addressable connection (e.g., using a web browser).

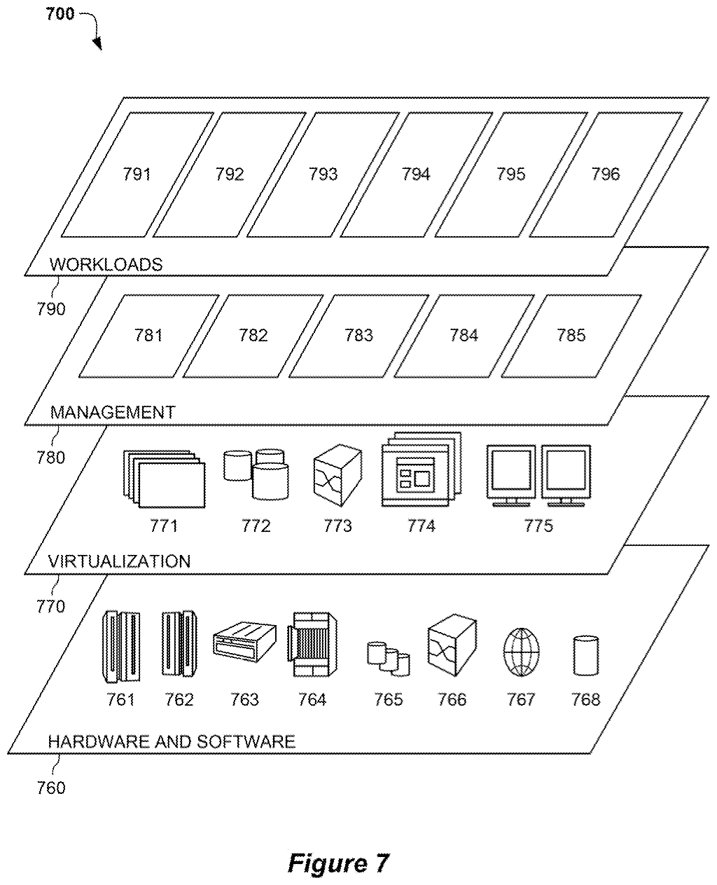

Referring now to FIG. 7, a set of functional abstraction layers provided by cloud computing environment 60 (as shown in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 760 includes hardware and software components. Examples of hardware components include: mainframes 761; RISC (Reduced Instruction Set Computer) architecture based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772, for example the nodes 110 as shown in FIG. 3; virtual networks 773, including virtual private networks; virtual applications and operating systems 774; and virtual clients 775.

In an example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In an example, these resources may include application software licenses. Security provides identity verification for cloud consumers and tasks, as well as protection for data and other resources. User portal 783 provides access to the cloud computing environment for consumers and system administrators. Service level management 784 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and anomaly detection program 796. The anomaly detection program 796 may detect an anomaly in a computer system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting an anomaly in a computer system, the method comprising:
accessing a first timeseries of measured values of a quantity related to operation of the computer system, the first timeseries spanning a first time period;
based on the first timeseries accessed, performing timeseries forecasting to infer a second timeseries of values for the quantity, the second timeseries spanning a second time period up to a given time horizon;
accessing a third timeseries of measured values of the quantity, the third timeseries spanning the second time period up to the time horizon;
comparing the second timeseries inferred with the third timeseries accessed to obtain a comparison outcome; and
based on the obtained comparison outcome, determining a first anomaly score to potentially detect an anomaly in the computer system.

2. The method according to claim 1, further comprising:
obtaining a second anomaly score based on the third timeseries accessed, using a cognitive anomaly detection scheme that differs from the timeseries forecasting; and
weighting each of the first anomaly score and the second anomaly score to obtain a third anomaly score based on weighted contributions of the first anomaly score and the second anomaly score.

3. The method according to claim 2, wherein
the cognitive anomaly detection scheme comprises one of an autoencoder, a variational autoencoder, and a convolutional neural network.

4. The method according to claim 2, further comprising:
performing a predictability test in respect of the first timeseries accessed, by detecting a temporal pattern, and assessing this temporal pattern to obtain an assessment result; and
based on the assessment result, determining an extent to which the first anomaly score can be taken into account in determining the third anomaly score, and accordingly weighting the first anomaly score and the second anomaly score.

5. The method according to claim 4, wherein
the temporal pattern is detected by computing an output of a function taking the first timeseries as argument, the function comprising one or more of an autocorrelation function, a Fourier transform, and a wavelet transform.

6. The method according to claim 5, wherein
the function includes the autocorrelation function.

7. The method according to claim 6, further comprising:
selecting top-k peaks of output of the autocorrelation function, based on their intensities, whereby the temporal pattern is assessed based on attributes of the selected peaks.

8. The method according to claim 7, wherein
the top-k peaks are selected by thresholding peaks of the output of the autocorrelation function.

9. The method according to claim 1, further comprising:
instructing to take action in respect of the computer system, when the first anomaly is detected, based on the first anomaly score, to modify a functioning of the computer system.

10. The method according to claim 1, wherein
the method is performed for multiple timeseries corresponding to respective quantities related to the operation of the computer system, whereby multiple first timeseries are accessed, all spanning the first time period.

11. The method according to claim 10, further comprising:
performing a predictability test in respect of the multiple first timeseries accessed, by detecting a temporal pattern and assessing this temporal pattern to obtain an assessment result, whereby the first anomaly score is further determined based on the assessment result.

12. The method according to claim 11, wherein
the temporal pattern is detected by computing autocorrelation functions of each of the multiple first timeseries, summing resulting autocorrelation functions, and selecting top-k peaks of the summed autocorrelation functions, based on their intensities, whereby the temporal pattern is assessed based on attributes of the selected peaks.

13. The method according to claim 1, wherein
the method is performed for multiple timeseries, whereby multiple first timeseries of measured values of quantities related to the operation of the computer system are accessed, wherein each of the multiple first timeseries spans a respective one of first time periods, which are least partly overlapping.

14. The method according to claim 1, wherein
the method is implemented to monitor the computer system for anomalies in real time, whereby the third timeseries is accessed upon reaching the time horizon and the second timeseries inferred is compared with the third timeseries accessed upon accessing the third timeseries.

15. The method according to claim 14, wherein
the method is performed in respect of multiple, time-overlapping timeseries.

16. The method according to claim 14, wherein
the method is performed at a given computer, which is in data communication with the computer system.

17. A computer system for detecting an anomaly in a computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
accessing a first timeseries of measured values of a quantity related to operation of the computer system, the first timeseries spanning a first time period;
based on the first timeseries accessed, performing timeseries forecasting to infer a second timeseries of values for the quantity, the second timeseries spanning a second time period up to a given time horizon;
accessing a third timeseries of measured values of the quantity, the third timeseries spanning the second time period up to the time horizon;
comparing the second timeseries inferred with the third timeseries accessed to obtain a comparison outcome; and
based on the obtained comparison outcome, determining a first anomaly score to potentially detect an anomaly in the computer system.

18. The computer system according to claim 17, further comprising one or more nodes of the computer system.

19. A computer program product for detecting an anomaly in a computer system, the computer program product comprising:
one or more computer-readable tangible storage medium and program instructions stored on at least one of the one or more tangible storage medium, the program instructions executable by a processor, the computer program product is capable of performing a method comprising:
accessing a first timeseries of measured values of a quantity related to operation of the computer system, the first timeseries spanning a first time period;
based on the first timeseries accessed, performing timeseries forecasting to infer a second timeseries of values for the quantity, the second timeseries spanning a second time period up to a given time horizon;
accessing a third timeseries of measured values of the quantity, the third timeseries spanning the second time period up to the time horizon;
comparing the second timeseries inferred with the third timeseries accessed to obtain a comparison outcome; and
based on the obtained comparison outcome, determining a first anomaly score to potentially detect an anomaly in the computer system.

20. The computer program product according to claim 19, further comprising:
obtaining a second anomaly score based on the third timeseries accessed, using a cognitive anomaly detection scheme that differs from the timeseries forecasting; and
weighting each of the first anomaly score and the second anomaly score to obtain a third anomaly score based on weighted contributions of the first anomaly score and the second anomaly score.
